(19) United States
(12) Patent Application Publication
(10) Pub. No.: US 2009/0229363 A1
(43) Pub. Date: Sep. 17, 2009

(54) Method for Detecting and Classifying Defects in Building Components by Means of Ultrasound

(75) Inventors: Boris Milmann, Berlin (DE); Martin Krause, Berlin (DE); Frank Mielentz, Berlin (DE); Klaus Mayer, Kassel (DE)

Correspondence Address: FAY KAPLUN & MARCIN, LLP, 150 BROADWAY, SUITE 702, NEW YORK, NY, 10038, US

(73) Assignee: BAM Bundesanstalt Fur Material-Forschung Und- Prufung, Berlin (DE)

(21) Appl. No.: 12/302,176

(22) PCT Filed: Jun. 1, 2007
(86) PCT No.: PCT/EP2007/005029

§ 371 Date: Apr. 6, 2009

(30) Foreign Application Priority Data
Jun. 2, 2006 (DE) 10 2006 027 132.7

(51) Int. Cl. G01N 29/04

(52) U.S. Cl. 73/600

(57) ABSTRACT

A method for detection and classification of imperfections in components is proposed having the following stages: Irradiation of pulsed ultrasonic waves from electrical emission pulses on several points of the surface of the component to be examined, reception of the reflected ultrasonic waves at several points of the surface for generating multiple electrical reception signals, analysis and evaluation of the electrical reception signals in terms of their amplitude information with reference to the positions of the points of the irradiated ultrasonic waves and the detected reflected sound waves for generating a three-dimensional spatial distribution of the scattering properties of the component. In addition to the amplitude information, the phase angle of scattering readouts is evaluated and the phase information is assigned to the three-dimensional spatial distribution of the scattering properties of the component, with the amplitude information being invoked for detecting the imperfections, and the amplitude information and the phase information of the three-dimensional spatial distribution being invoked for classification.

The invention relates to a method for detecting and classifying defects in building components, in particular pressure defects in prestressing cuts or compaction defects in concrete building components according to the preamble of the main claim.

It is known to apply ultrasonic testing methods in a large number of different building components. Also structures in buildings, e.g. made of concrete or similar materials, are tested inter alia. Many contemporary concrete buildings are so-called prestressed concrete buildings. The property of concrete of having only a relatively low tensile strength is approached by a synthetic inner prestressing of the objects by means of steel cables or tensioning wires. The steel cables are guided in so-called prestressing cuts or also jacket tubes and are tensioned after setting of the concrete. Thereafter, the jacket tubes are filled with grouting mortar in order to achieve a strong bond between the steel cables and the concrete construction. It is thereby important that the grouting mortar fills the jacket tubes completely and surrounds the tensioning wires without gaps since moisture can accumulate in cavities and the tensioning wires can be attacked and destroyed by corrosion. Such cavities or pressure defects in prestressing cuts represent a lack of quality which in the extreme case leads to failure of the building component and to the building caving in. For assessment of the stability of a concrete construction, knowledge about the compaction defects and gravel voids is likewise essential.

For detection of defects in building components, the ultrasonic echo method is also known, in which ultrasonic waves are irradiated into the surface of the object to be examined and the reflected soundwaves are detected. The result thereby is scattering processes and, as a function of the intensity of the reflection, defects must be concluded. The detection of prestressing cuts is based on the intensity of the reflection from the jacket tube side which is orientated towards the measuring surface. In the case of air inclusions, this is more significantly intensive in comparison with well compacted regions (see Krause, M., Mielentz, F., Milmann, B., Streicher, D., Müller, W., Ultrasonic imaging of concrete elements: State of the art using 2D synthetic aperture, in: DGZfP (Ed.): International Symposium of Non-Destructive Testing in Civil Engineering (NDT-CE) in Berlin, Germany, Sep. 16-19, 2003, Proceedings on BB 85-CD, V51, Berlin (2003);

Kroggel, O.; Scherzer, J.; Jansohn, R.: The Detectability of Improper Filed Ducts With Ultrasound Reflection Techniques. NDT.net—March 2002, Vol. 7, No. 03; Schickert, M.; Krause, M.; Müller, W.: Ultrasonic Imaging of Concrete Elements using SAFT Reconstruction, Journal of Materials in Civil Engineering 15 (2003) 3, pp. 235-246). In addition, the rear-side reflection of the jacket tube can be used for interpretation of the grouted state, which reflection occurs only in well-grouted portions.

The object underlying the invention is to produce a method for detecting and classifying defects in building components, which improves the reliability of the data in establishing defects relative to the ultrasonic echo method according to the state of the art.

This object is achieved according to the invention by the characterising features of the main claim in conjunction with the features of the preamble.

As a result of the fact that pulsed ultrasonic waves are irradiated into the concrete building component at a plurality of places and that the reflected ultrasonic waves are received likewise at a plurality of places of the surface and that subsequently the high frequency electrical reception signals using the positions of the places of the irradiation and reception are analysed and evaluated in order to generate a three-dimensional local distribution of the scattering properties of the object, the phase value of the scattering process being evaluated in addition to the amplitude information and the phase information being assigned to the three-dimensional local distribution of the scattering properties of the object and the amplitude information being used for locating defects and the amplitudes and the phase information of the three-dimensional local distribution being used for classifying the defects (harmless scattering readings or actual damaging defects), the significance and reliability of the data is significantly improved when establishing defects, e.g. pressure defects.

The phase position together with the amplitude information of the scattering process is hence used for characterisation of the state of the building component, for example of the prestressing cut. The amplitude and phase information are evaluated from the result of reconstructions since the measuring data are thereby focused better on the scattering process and a spatial separation of different scattering processes is achieved. This evaluation can be effected manually by analysis of the graphical representation of the sections and projections from the three-dimensional local distribution of the 2D or 3D SAFT reconstruction in the form of signed B-images and C-images or by automation by calculating the respectively local phase value.

The classification of the reflector, e.g. the unfilled jacket tube, is achieved in this way because the difference of the phase value between the acoustically denser reflector, e.g. steel, and the compaction fault, e.g. air, is evaluated. Such a method can also be applied for detection of compaction defects and gravel voids in the concrete, the latter being able to be distinguished from reinforcing rods by evaluation of the phase position.

The method according to the invention allows automated data recording, evaluation and documentation, wherein crude data, reconstructions, geometric information and phase evaluation are determined, visualised and stored with respect to the object.

The method according to the invention is explained subsequently in more detail with reference to the accompanying Figures. There are shown:

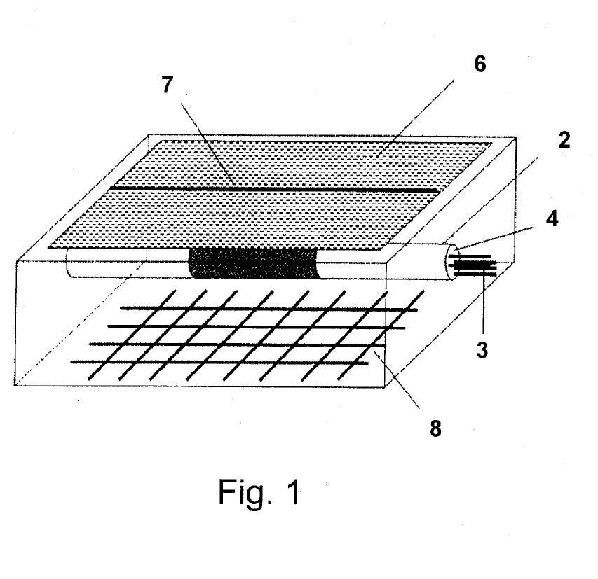

FIG. 1 a perspective schematic view of a concrete building component as test body,

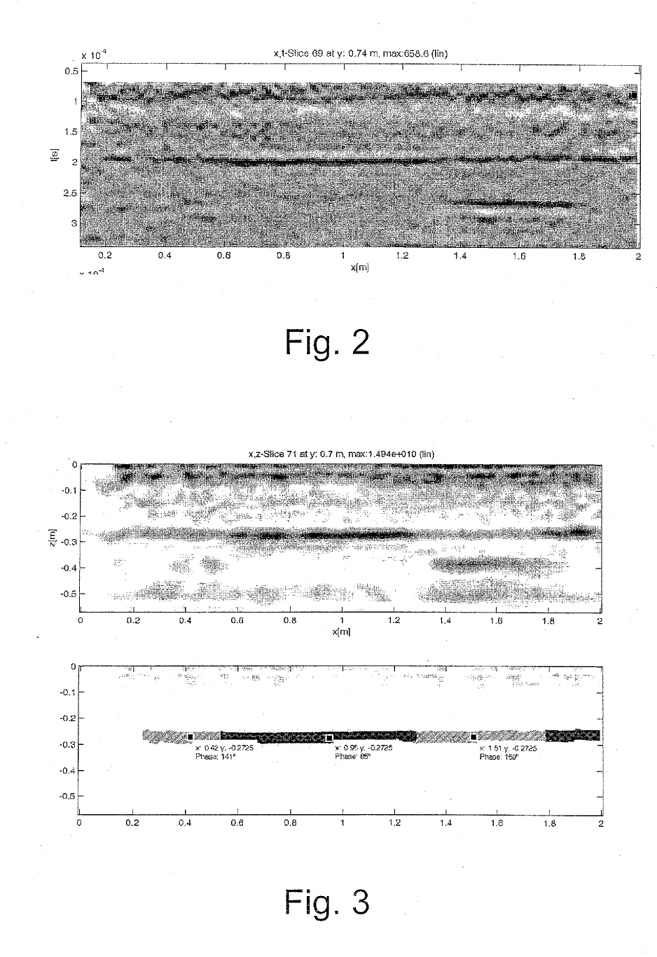

FIG. 2 a representation of a section from the measuring data before the reconstruction,

FIG. 3 an amplitude and phase representation of the three-dimensional reconstruction of the measuring data in a depth section,

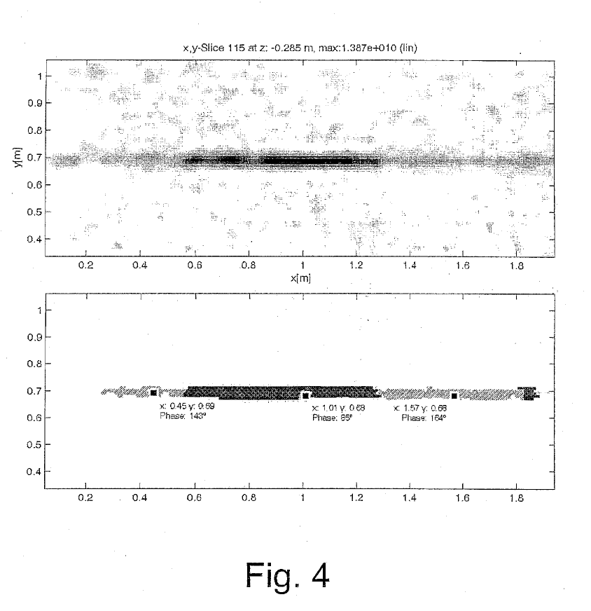

FIG. 4 an amplitude and phase representation of the three-dimensional reconstruction of the measuring data in the section parallel to the measuring surface,

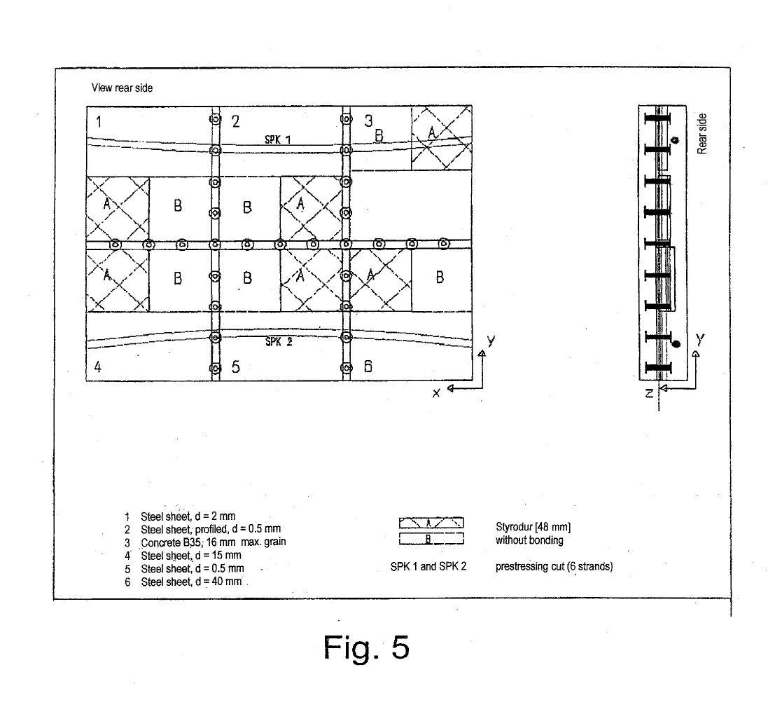

FIG. 5 a construction plan of a further example of a concrete building component with metal and Styrodur plates encased in concrete,

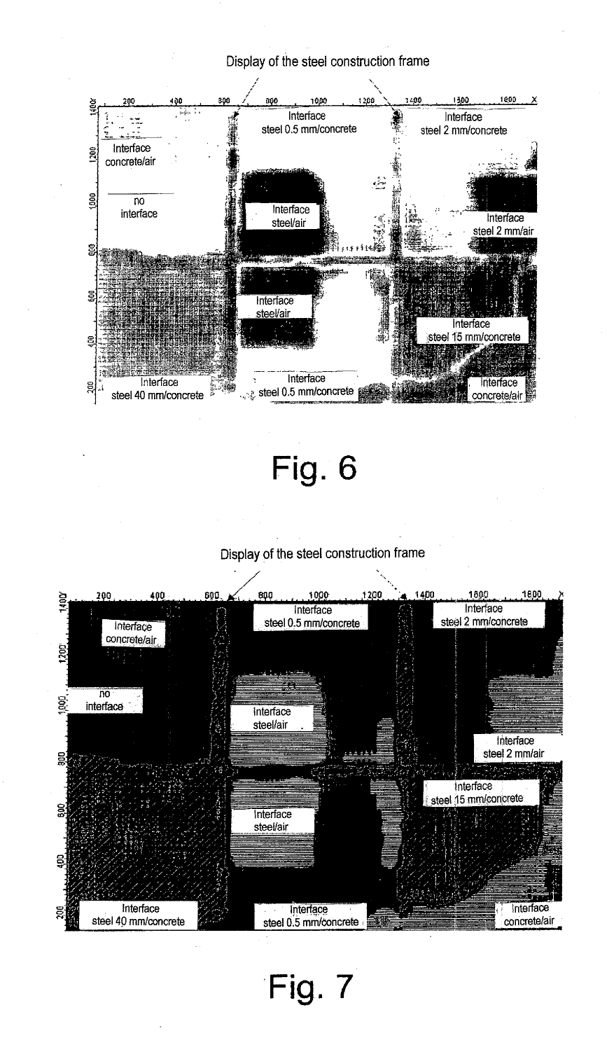

FIG. 6 a reconstruction of the measuring data with respect to the amplitude as a section in the depth of the metal plates and

FIG. 7 a reconstruction of the measuring data with respect to the phase as a section in the depth of the metal plates.

In the case of the method according to the invention which is explained with reference to concrete building components, ultrasonic waves are coupled into the concrete building component via suitable ultrasonic transducers and the ultrasonic waves which are reflected on the rear side of the concrete component or at defects, reinforcements and other material jumps are received by the ultrasonic transducers. Suitable ultrasonic transducers are for example those transducers which operate on a piezoelectric basis and require no coupling means. For example a plurality of individual transducers which are disposed in an array are used, said transducers having resiliently mounted contact tips. One or more of the individual transducers can thereby operate as transmitters, whilst the others serve as receivers. The reception signals are converted into processable digital data and stored. In order to be able to examine the entire building component, the ultrasonic measurement is implemented in a dense grid on the accessible surface of the building component. Care must thereby be taken that the measuring data are qualitatively of high value. In addition, the transmitting and receiving positions of the ultrasonic transducers or sensors are recorded and stored.

In the known state of the art, the detected crude data which are informative with respect to the amplitude of the received ultrasonic waves, are evaluated together with the positional data of the ultrasonic sensors with a 3D imaging method, such as a 3D SAFT algorithm (Synthetic Aperture Focusing Technique), as a result of which the volume of the building component is reconstructed three-dimensionally and as a result of which the interior of the concrete building component is imaged acoustically and the local distribution of the scattering properties is displayed.

Locating pressure defects in prestressing cuts as a concrete embodiment is hence based inter alia on the measurement of an intensity difference of the reflection of ultrasonic pulses on the tensioning members, a quasi total reflection taking place at air inclusions which represent pressure defects, i.e. the reflection coefficient assumes its maximum possible value. Relative hereto, the reflection is less at well-grouted jacket tubes since parts of the sound penetrate into the jacket tube through the thin jacket tube wall and the grouting mortar.

For the evaluation, sections and projections can hence be derived from the three-dimensional reconstruction of the scattering properties, which sections and projections are known as B-images and C-images, the C-images being situated parallel to the irradiation surface (parallel to the X-, Y-plane), whilst the B-images are sectional planes through the material in the direction of the irradiation.

On these images, the depth and intensity distribution of the reflection can be read off, from which in turn it can be established where defects are present. The intensity distributions are provided from standard reconstructions in a choosable depth grid. The coordinates are then selected in which a reflector is discovered or anticipated. In total, the visualisation process is interactive.

For reliable locating of pressure defects, a sufficiently clear difference in the reflection between well-grouted and air-filled regions is required. In practice, this is not always achieved since the ultrasonic propagation is influenced in addition by the conventional reinforcement, the quality of the sound trans-mission on the concrete surface and the state of the concrete. The phase change of the ultrasonic pulses caused by the reflection is therefore used, corresponding to the invention, for the classification in addition to amplitude information, i.e. for the intensity differences of the reflection of ultrasonic pulses within the building component, i.e. the phase of the reflected signal is observed.

It is known that an ultrasonic pulse (sound pressure) measured with a piezoelectric converter maintains its pulse form when reflected on an acoustically denser material, whilst a phase jump of 180°, i.e. a pulse reversal, is produced when reflected at an interface to a thinner material, i.e. the phase is maintained during a reflection on steel, whilst the phase jump occurs in air.

Since in concrete building components the reflections of different interfaces are superimposed, the transition from jacket tube wall or steel strand to the grouting mortar, in the embodiment, respectively representing an additional interface, it is necessary to observe not only the phase jump of the reflected pulse but the phase rotation which is produced in total in a multilayer system. The above-sketched cases 0° and 180° phase position are special cases which can be easily understood with pulses and sinusoidal or cosinusoidal signals since a phase rotation of 180° in the case of cosine functions implies a sign reversal: cos(phi)=−cos(phi+180°). A pulsed signal can be divided into spectral components which are arranged in the case of ultrasonic excitation about a mean frequency (bandwidth signal), each spectral component comprising a phase-shifted cosine function. The spectrum is actually thereby continuous, i.e. there are all frequencies present but, in the case of a numerical spectral division (discrete Fourier transform DFT), discrete spectral lines are obtained. If for the sake of simplicity only the spectral line in the case of the mean frequency of the test body is observed, then a cosine oscillation with an amplitude and a phase position is part thereof. The phase position relates however to the initial time of the spectral analysis and this can be chosen freely. Therefore the phase position of the spectral line and hence the phase position of the analysed pulse can be determined apart from merely an offset. Since the phase position must be determined for the scattering process, the starting time of the transmission signal must not be used as reference point but rather a typical time in the received scattering pulse. In the case of a symmetrical pulse, the pulse peak can easily be “fixed” and then the peak is identified as positive or negative and hence at 0° or 180° phase position.

In contrast, in the case of pulses which are produced by scattering on non-flat surfaces or on layers, a superposition of a large number of pulses is always present (with only one frequency this would be termed interference), which change the symmetry of the total pulse, and hence establishing the reference point no longer becomes obvious and the analysis of the phase position becomes arbitrary.

The difference between signal evaluation and reconstruction is represented subsequently for better understanding. The above statements relate to the measured ultrasonic signal. Imaging methods such as 3D-SAFT which start from a one-sided measuring surface transmit the phase information (as a result of a lack of a delimited resolution capacity) for the reconstruction and the signals are replaced by synthetically focused B-images. More precisely, the time coordinate with the signal is replaced by the depth coordinate in the reconstruction (in the embodiment, the z-coordinate). The displayed phase value in both cases is not identical but has the same tendency. This is produced from the complex structure of the SAFT algorithm which partially corrects some causes of the phase rotation in the scattering signal (scattering geometry-dependent components) but not others (thin layers, multiple reflections). The resolution in the reconstruction in the depth direction is essentially identical to the resolution of the time signals, the path (wavelength) must merely be standardised with the help of the propagation speed. However the focused B-image of the reconstruction is substantially more noise-free than the data and therefore the phase determination functions better.

By means of an algorithm, the phase of the reflected ultrasonic pulses is also evaluated and a three-dimensional reconstruction is calculated on the basis of the phase information. The phase rotation is produced from the result in the case of the reflection in a colour scale corresponding to the B- or C-images, as a result of which it is possible to read off the value of the phase rotation with local resolution.

At the present time, the process for determining the phase position of the scattering process takes place as follows:

Phase determination from the pulse form of the reconstruction:

### Method a):

The depth scale from the amplitude images is used and the signal course is observed in the depth of an expected scattering process (upper edge jacket tube or the like) and then the sign of the main pulse is detected.

### Method b):

A mathematical envelope is calculated via the B-image (or the signal)—this is a type of intensity value formation—the centre of the display is found in this way and the sign of the (non “enveloped”) original B-image is analysed at this position.

Computing method:

The envelope of the B-image (or of the signal) is calculated and the maximum of the envelope defined as phase-reference point. From this point, the pulse of an oscillation of the mean frequency is cut free to the right and to the left and, via a Fourier transform of this section, the phase value of the spectral line is determined at the mean frequency which can now assume values of 0°-360°. This value is assigned to the respective scattering centre. Therefore phase values for the total B-image are not obtained but only for scattering centres. The selection of the scattering centres is effected via a threshold value of the envelope which is adjustable.

The calculation is portrayed roughly above; there are included as parameters: wavelength at the mean frequency, two section parameters for the width of the signal window to be cut out and also the threshold value of the identification sensitivity. In the current implementation, the phase information for the entire reconstruction is calculated and thereafter the sections can be represented interactively together with the amplitude information. In order to determine the geometric correlation more simply in an image, the amplitude image in the phase image is displayed as a black-and-white image for values less than the identification threshold. In addition, the phase information is represented as a coloured value which jointly contains the amplitude as lightness value. With the help of cursors, the phase value can be displayed as a numerical value at any point of the reconstruction.

FIG. 1 shows the schematic representation of a concrete building component 1 as test body with a jacket tube 2 in which steel strands 3 are inserted and fixed by means of grouting mortar 4. A pressure defect 5, i.e. a non-grouted region, is represented hatched. At the top in the Figure, the measuring surface and in particular a measuring line 7 is disposed above the jacket tube 2 on the concrete building component 1 and, at the bottom in the same, a conventional reinforcement 8. In the actual building component, normally a reinforcing layer can be found also between jacket tube 2 and measuring surface 6, which is not taken into account here however.

In FIGS. 2 to 4, the evaluation of the ultrasonic waves which are irradiated into the test body and reflected is represented.

FIG. 2 shows a section (B-image) of the planar measurement along a line above the jacket s over the location□tube 2 in x direction for y−0.67 m, i.e. the time t×10×in m. It can be detected from the course of the amplitude of the measuring signals that a pulse deformation occurs in one region of the jacket tube 2 which was manufactured as non-grouted. In fact, also an amplitude change can be detected, which might however originate from the conventional reinforcement between jacket tube 2 and measuring surface (in fact such a region exists in the test body).

FIG. 3 shows at the top the amplitude evaluation and, at the bottom, the phase evaluation of the 3D-FT-SAFT reconstruction of the measuring data according to FIG. 2 as B-image, i.e. as depth section x, z with y=0.7 m. Analysis of the data shows that the phase provides significantly different values between grouted and non-grouted region (approx. 150° relative to 86°). Since the Figures cannot be reproduced as colour images, they are represented and labelled as black/white images with additional hatching of the relevant readings.

FIG. 4 shows a slice (C-image; x, y) of the 3D-FT-SAFT reconstruction of the measuring data of FIG. 2 with respect to the evaluation of the amplitude (above) and the phase (below) parallel to the measuring surface at a depth of the upper edge of the jacket tube 2 (z=−0.285 m). The non-grouted region here is also readily detectable.

In FIG. 5, a further example of a test body, namely a plate test body, is represented from the rear side and in section, which has a plurality of metal plates 1, 2 and 4 to 6 of different thicknesses which are poured with concrete with application of Styrodur A which is intended to represent air. The field 3 is filled with concrete and Styrodur without metal. The positions without Styrodur bonding are designated with B. SPK1 and SPK2 are prestressing cuts which are located behind the metal plates.

The reconstructions indicated in FIGS. 6 and 7 are sections at a depth of approx. 10 cm, i.e. at the depth of the upper edges of the metal plates, viewed from the front. The Styrodur plates A are located under the metal plates and as a function of the respective thicknesses of the same at different depths. Because of the resolution of the reconstruction, Styrodur plates A can be seen behind the thin metal sheets in the plane of the same. In the case of thick metal plates, they are however outwith the represented depth range. The Styrodur plate in the region 3 without metal sheet is moved out of position during production and likewise is located outwith the indicated region. FIG. 6 is a SAFT reconstruction of measuring data with respect to the amplitude on the concrete part according to FIG. 5. In the evaluation, echo readings of interfaces can be detected clearly. More precise data about the type of interface, such as solid/solid or solid/gaseous (here for instance concrete/steel or steel/air inclusion), cannot be achieved. FIG. 7 is the reconstruction with respect to the phase, the phase of the reflected pulses now making possible information about the type of interfaces. The visual detection is thereby based on a representation of different colours which is provided here in black/white or different grey scale values.

1-6. (canceled)

7. A method for detecting and classifying defects in a building component, comprising:
irradiation, by pulsed ultrasonic waves from electrical transmission pulses, at a plurality of places of a surface of the building component to be examined;
receiving reflected ultrasonic waves from the plurality of places of the surface to generate a plurality of electrical reception signals;
analyzing and evaluating the high-frequency electrical reception signals, using positions of the places of the irradiated ultrasonic waves and the received reflected sound waves, to generate a three-dimensional local distribution of scattering properties of the building component;
determining phase information and amplitude information of a scattering and assigning to the three-dimensional local distribution of the scattering properties;
detecting the defects as a function of the amplitude information; and
classifying the defects as a function of the amplitude information and the phase information of the three-dimensional local distribution.

8. The method according to claim 7, wherein the irradiation and reception of ultrasonic waves is implemented in a dense grid on the surface of the component.

9. The method according to claim 7, wherein the amplitude information and the phase information of the local distribution of the scattering properties, which is determined using a three-dimensional imaging method, is analyzed and evaluated.

10. The method according to claim 9, wherein the three-dimensional imaging method includes a 3D-SAFT algorithm.

11. The method according to claim 7, wherein sections and projections from the three-dimensional local distribution of the scattering properties are represented pictorially, the amplitude information and the phase information respectively being contained in one of (a) color and (b) in steps of grey in the representations of the sections and projections.

12. The method according to claim 7, wherein the analysis is implemented using signed B-images and C-images.

13. The method according to claim 7, wherein at least one of (a) pressure defects in prestressing cuts and (b) compaction defects and gravel voids in concrete building components are detected and classified.
